(19) United States
(12) Patent Application Publication
(10) Pub. No.: US 2013/0090937 A1
(43) Pub. Date: Apr. 11, 2013

(54) System and method for facilitating patient compliance with prescription medication regimen

(71) Applicant: Joel Wright, Lake Villa, IL (US)

(72) Inventor: Joel Wright, Lake Villa, IL (US)

(73) Assignee: WALGREEN CO., Deerfield, IL (US)

(21) Appl. No.: 13/267,471

(22) Filed: Oct. 6, 2011

(51) Int. Cl. G06Q 50/24

(52) U.S. Cl. 705/2

(57) ABSTRACT

The method, system and user-interface facilitates patient compliance with healthcare provider instructions for prescription medication after discharge from a healthcare facility by analyzing patient current medication, canceling open prescriptions no longer used by the patient, aligning verified patient current prescriptions with patient discharge prescriptions, thus limiting the number of occasions on which a customer must visit the pharmacy to retrieve refills of the aligned prescriptions, and providing follow-up education at multiple occasions after discharge, decreasing the likelihood that the patient will be re-admitted to the hospital for the same ailment or complications from that ailment and increasing the likelihood that the customer will comply with the recommended medication regimen.

### FIELD OF INVENTION

The present disclosure generally relates to a process for facilitating patient compliance with prescription medications and instructions provided upon discharge from a healthcare facility.

### BACKGROUND

Generally, when a patient is admitted to a hospital, the patient is treated for a particular ailment for which he or she was admitted, prescribed medications for post-discharge treatment for that ailment, and released to his or her home without further follow-up or assistance. Whether the patient follows post-discharge instructions and appropriately uses the medications prescribed is largely unregulated by any healthcare provider, healthcare facility, or pharmacist. Often, post-discharge instructions are confusing or post-discharge medications cause unforeseen or uncomfortable side-effects. In other cases, the patient may have a history of non-compliance with prescription medications, based on any number of causes, such as difficulty of refilling said prescriptions, lack of adequate instruction, sheer forgetfulness, etc. In any event, failure to comply with post-discharge instructions or a post-discharge medication regimen may cause entirely preventable hospital readmission. In fact, currently, one in five elderly patients is readmitted to the hospital within 30 days after discharge.

Preventable hospital readmissions cost the American healthcare system an estimated $25 billion annually, according to studies conducted in 2008. According to recent changes in the healthcare structure of our country, a hospital's governmental compensation can be cut by up to 1% if they exceed an expected 30-day readmission rate for patients with heart failure, heart attack, or pneumonia starting in October 2012. This means that a hospital with 250 heart failure patients and a readmission rate 20% higher than predicted stands to lose $250,000 in Medicare compensation. Approximately 40% of readmissions are entirely avoidable by ensuring patient compliance with post-discharge prescriptions and instructions. There is currently no system for facilitating patient compliance with post-discharge prescriptions and instructions.

### SUMMARY OF THE INVENTION

The disclosed method and system provide an elegant process for facilitating patient compliance with prescribed medication post-discharge from a healthcare facility, thereby lessening the chance that a patient will be re-admitted to the hospital within a relatively short time period for the same ailment.

The disclosed method and system retrieves a patient's medication history, including any and all open prescriptions associated with the patient, and analyzes the medication history to determine the likelihood that any one or more open prescriptions in the patient's medication history is currently being appropriately followed by the patient. The resulting list of active open prescriptions is presented to a healthcare professional, who may cross-check the list of active open prescriptions with the patient. The healthcare professional may then return a verified list of patient current prescriptions, along with a list of discharge prescriptions, to the pharmacy. The pharmacy may close any open prescriptions associated with the patient that do not appear on the verified list of patient current prescriptions or the list of discharge prescriptions. The pharmacy may then align the remaining prescriptions so that the patient and/or the patient's caregiver will be able to fill all prescriptions at the same time and on the same cycle. The prescriptions are then delivered bedside to the patient and/or caregiver, along with detailed instructions on how to use the prescriptions so as to achieve maximum results and benefits. The patient may be contacted a short period after discharge from the healthcare facility to ensure compliance immediately post-discharge and to check for any troubling side-effects or other signals that a healthcare provider should be contacted. The patient may be contacted again a short period of time before the first refill date in order to ensure compliance and to check for any troubling side-effects or other signals that a healthcare provider should be contacted. At this point, the patient has the option to refill his or her prescriptions at the pharmacy of his or her choice, be that the current pharmacy or another pharmacy. The results of the follow-up contacts are then reported to track trends in patient compliance and the success of the program, the healthcare professional, and the healthcare facility.

### BRIEF DESCRIPTION OF THE DRAWINGS

FIGS. 1A-1C illustrate block diagrams of a computer network, a computer server, and computing terminals on which an exemplary patient compliance facilitation system may operate in accordance with the described embodiments;

FIGS. 2-7 illustrate an exemplary process for facilitating patient compliance with post-discharge prescription medications in accordance with the described embodiments; and

FIGS. 8-9 illustrate an exemplary user-interface for use in a patient compliance facilitation system.

### DETAILED DESCRIPTION

Although the following text sets forth a detailed description of numerous different embodiments, it should be understood that the legal scope of the invention is defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph.

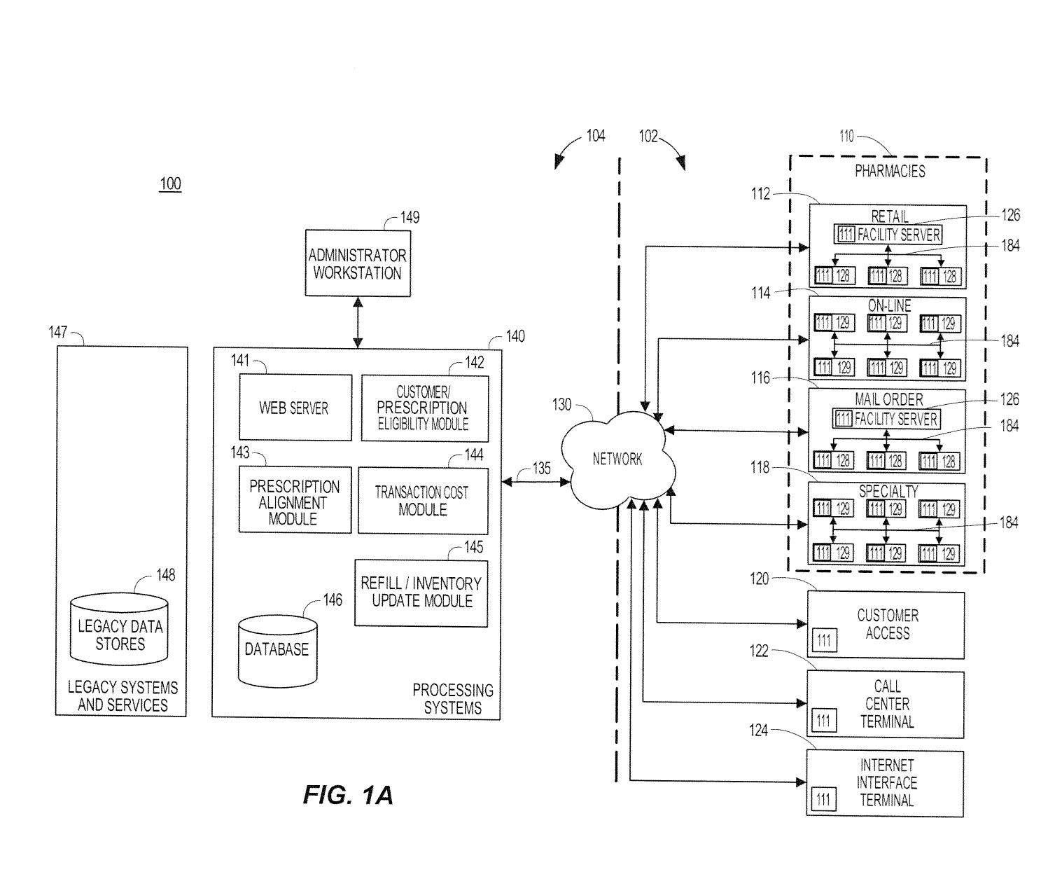

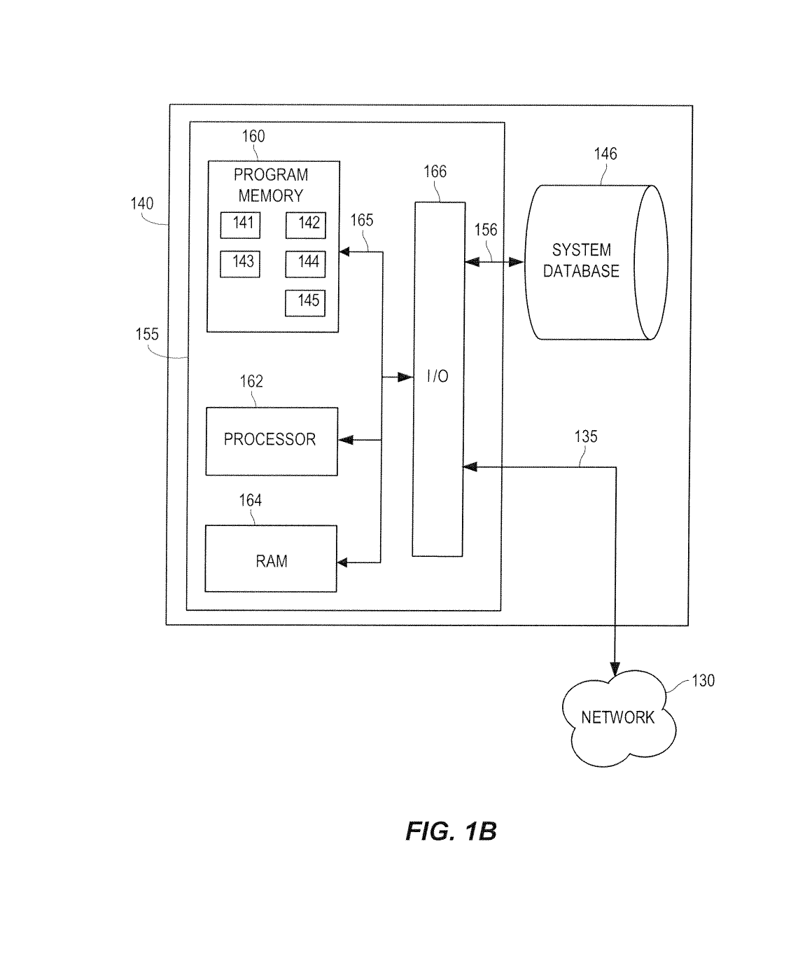

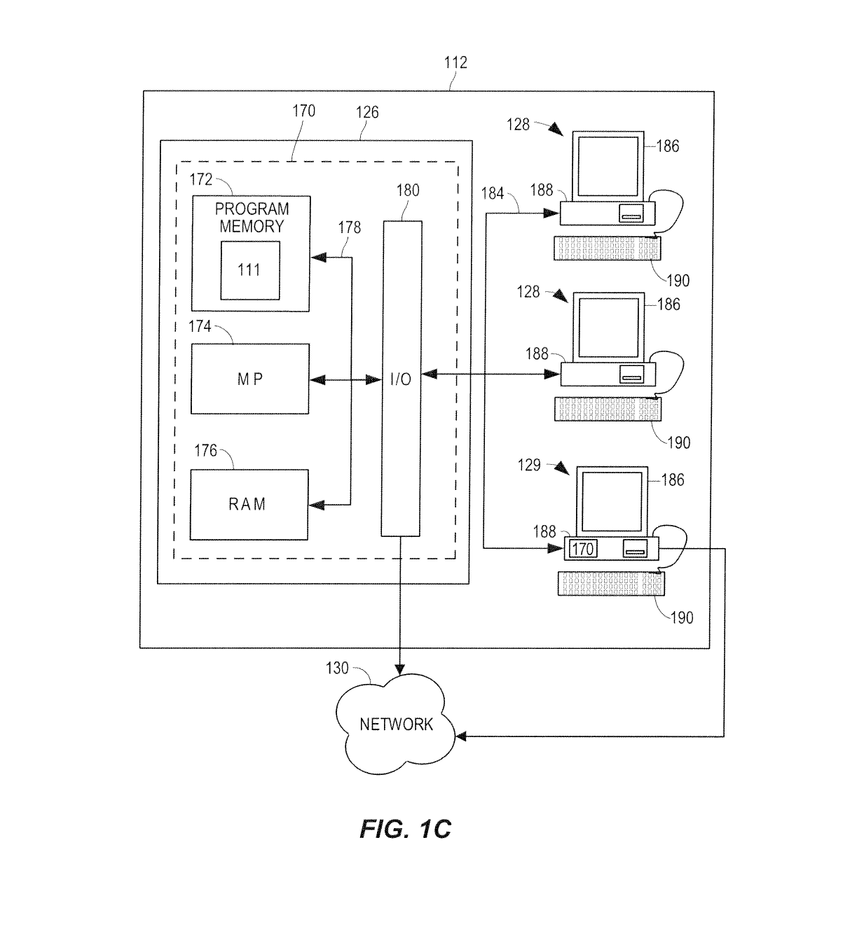

FIG. 1 illustrates a block diagram of an exemplary patient compliance facilitation system 100. The high-level architecture includes both hardware and software applications, as well as various data communications channels for communicating data between the various hardware and software components. The patient compliance facilitation system 100 may be roughly divided into front-end components 102 and back-end components 104. The front-end components 102 are disposed within a plurality of pharmacies 110. The plurality of pharmacies 110 may be located, by way of example rather than limitation, in separate geographic locations from each other, including different areas of the same city, different cities, or different states. The front-end components 102 comprise a plurality of pharmacy workstations 129. The pharmacy workstation 129 are local computers located in the various pharmacies 110 and executing various pharmacy management-related applications. Pharmacists and technicians (not shown) use the pharmacy workstations 129 to access customer information, enter new prescriptions, access insurance and payment information and so forth. Thus, the front-end components 102 may include a plurality of pharmacy workstations 129 for servicing customers visiting an in-store retail pharmacy 112, a plurality of pharmacy workstations 129 for servicing customers who choose to fill their prescriptions through an on-line pharmacy 113, a plurality of pharmacy workstations 129 for servicing customers who prefer to use the services of a mail-order pharmacy 116, and a plurality of pharmacy workstations 129 for servicing customers who require the services of a specialty pharmacy 118.

Those of ordinary skill in the art will recognize that the front-end components 102 could also comprise a plurality of facility servers 126 and client device terminals 128 or disposed at the plurality of pharmacies 110, instead of or in addition to a plurality of facility servers 126 and client device terminals 128 or disposed at the plurality of pharmacies 110, instead of or in addition to a plurality of pharmacy workstations 129. Each pharmacy 112, 114, 116, 118 may include one or more facility servers 126 that may be utilized to facilitate communications between the client device terminals 128 and the back-end components 104 via a network 130, described below, and to store information for a plurality of customers/employees/accounts/etc. associated with each facility. Further, each pharmacy 112, 114, 116, 118 may include one or more client device terminals 128 operatively connected to the facility server 126 via a local network 184. Unless otherwise indicated, any discussion of workstation 129 also refers to facility servers 126 and client device terminals 128, and vice versa.

The front-end components 102 communicate with the back-end components 103 via the network 130. The network 130 may be a proprietary network, a secure public internet, a virtual private network or some other type of network, such as dedicated access lines, plain ordinary telephone lines, satellite links, combinations of these, etc. Where the network 130 comprises the Internet, data communications may take place over the network 130 via an Internet communication protocol. The back-end components 103 include patient record processing systems 140 and legacy systems 147. The legacy systems 147 include legacy data stores (e.g., a database) 148. The legacy systems 147 execute software applications and store data supporting the operation of the front-end components 102. The patient record processing systems 140 may include one or more computer processors adapted and configured to execute various software applications and components of the patient compliance facilitation system, in addition to other software applications, such as a medication management system. The processing systems 140 further include a patient record database 146. The patient record database 146 is adapted to store data related to the operation of the patient compliance facilitation system 100. The processing systems 140 may access data stored in the patient record database 146, as well as data stored in the legacy data stores 148, when executing various functions and tasks associated with the operation of the patient compliance facilitation system 100.

Although the patient compliance facilitation system 100 is shown to include one patient record processing system 140, one legacy system 147, and four pharmacies 112, 114, 116, and 118, it should be understood that different numbers of computers and pharmacies may be utilized. For example, the system 100 may include a plurality of processing systems 140 and legacy systems 147, and hundreds of pharmacies 110, all of which may be interconnected via the network 130. According to the disclosed example, this configuration may provide several advantages, such as, for example, enabling near real-time uploads and downloads of information as well as periodic uploads and downloads of information. This provides for a primary backup of all the information generated in the process of updating and accumulating pharmacy data.

FIG. 1B is a schematic diagram of one possible embodiment of the processing system 140, or the legacy system 147, shown in FIG. 1A. The processing system 140, or the legacy system 147, may have a controller 155 that is operatively connected to the database 146 or 148 via a link 156. It should be noted that, while not shown, additional databases may be linked to the controller 155 in a known manner.

The controller 155 may include a program memory 160, a processor 162 (may be called a microcontroller or a microprocessor), a random-access memory (RAM) 164, and an input/output (I/O) circuit 166, all of which may be interconnected via an address/data bus 165. It should be appreciated that although only one microprocessor 162 is shown, the controller 155 may include multiple microprocessors 162. Similarly, the memory of the controller 155 may include multiple RAMs 164 and multiple program memories 160. Although the I/O circuit 166 is shown as a single block, it should be appreciated that the I/O circuit 166 may include a number of different types of I/O circuits. The RAM(s) 164 and program memories 160 may be implemented as semiconductor memories, magnetically readable memories, and/or optically readable memories, for example. The controller 155 may also be operatively connected to the network 130 via a link 135.

FIG. 1C is a schematic diagram of one possible embodiment of the front-end components 102 located in one or more of the pharmacies 110 from FIG. 1A. Although the following description addresses the design of the pharmacies 110, it should be understood that the design of one or more of the pharmacies 110 may be different than the design of other pharmacies 110. Also, each of the pharmacies 110 may have various different structures and methods of operation. It should also be understood that the embodiment shown in FIG. 1C illustrates some of the components and data connections present in a pharmacy, however it does not illustrate all of the data connections present in a typical pharmacy. For exemplary purposes, one design of a pharmacy is described below, but it should be understood that numerous other designs may be utilized.

The pharmacies 110 may have one or more pharmacy workstations 129 or a facility server 126. The facility server 126 is operatively connected to a plurality of client device terminals 128 via a network 184. The network 184 also serves to operatively connect a plurality of workstations 129, where workstations are implemented. The network 184 may be a wide area network (WAN), a local area network (LAN), or any other type of network readily known to those persons skilled in the art. The facility server 126, client device terminals 128 or workstations 129 may also be operatively connected to the processing systems 140 from FIG. 1A via the network 130.

Each workstation 129, client device terminal 128 or facility server 126 includes a controller 170. Similar to the controller 155 from FIG. 1B, the controller 170 may include a program memory 172, a microcontroller or a microprocessor (MP) 174, a random-access memory (RAM) 176, and an input/output (I/O) circuit 180, all of which may be interconnected via an address/data bus 178. As discussed with reference to the controller 155, it should be appreciated that although only one microprocessor 174 is shown, the controller 180 may include multiple microprocessors 174. Similarly, the memory of the controller 180 may include multiple RAMs 176 and multiple program memories 172. Although the I/O circuit 180 is shown as a single block, the I/O circuit 180 may include a number of different types of I/O circuits. The RAM(s) 176 and program memories 172 may also be implemented as semiconductor memories, magnetically readable memories, and/or optically readable memories, for example.

The client device terminals 128 and workstations 129 may further include a display 186, a keyboard 190, as well as a variety of other input/output devices (not shown) such as a scanner, printer, mouse, touch screen, track pad, track ball, isopoint, voice recognition system, digital camera, etc. Each client device terminal 128 or workstation 129 may be signed onto and occupied by a pharmacy employee to assist them in performing their duties. Pharmacy employees may sign onto a client device terminal 128 or workstation 129 using any generically available technique, such as entering a user name and password. If a pharmacy employee is required to sign onto a client device terminal 128, this information may be passed via the link 184 to the facility server 126, so that the controller 170 will be able to identify which pharmacy employees are signed onto the system and which client device terminals 128 the employees are signed onto. This may be useful in monitoring the pharmacy employees' productivity.

FIG. 1A also illustrates a portable computing device or customer access terminal 120 that may form a portion of the patient compliance facilitation system 100. As used herein, the term “customer access terminal” is hereby defined to mean any sort of terminal or portable computing device capable of receiving and providing data associated with a prescription, a patient, or a customer. The customer access terminal 120 may be directly coupled to the network 130, may connect to the network 130 via the Internet, or, alternatively, may be a client device terminal 128 coupled to a facility server 126, as illustrated in FIG. 1C. The customer access terminal 120, like the workstation 129, may include a display 186, a controller 170, a keyboard 190 as well as a variety of other input/output devices such as a scanner, credit card reader, printer, mouse, touch screen, track pad, track ball, isopoint, voice recognition system, digital camera, electronic storage device reader (e.g., flash drive interface or magnetic media reader), etc. Each customer access terminal 120 may be placed at any location that provides a suitable connection to the network 130, and need not necessarily be located at a pharmacy location. The customer access terminal 120 may be accessed by any customer. Although only one customer access terminal 120 is illustrated in FIG. 1A, a plurality of customer access terminals 120 may be connected to the network 130.

A call center terminal 122, also depicted in FIG. 1A, may likewise form a portion of the patient compliance facilitation system 100. As used herein, the term “call center terminal” is hereby defined to mean any sort of terminal not located at a pharmacy, operated by someone other than the customer, and capable of receiving and providing data associated with a prescription, a patient, or a customer. For example, a call center terminal 122 may be disposed within a call center, or other such facility, where one or more operators receive information from customers over a telephone. The call center terminal 122 may be directly coupled to the network 130 or, alternatively, may be a client device terminal 128 coupled to a facility server 126, as illustrated in FIG. 1C. The call center terminal 122 may, like the workstation 129, include a display 186, a controller 180, a keyboard 190, as well as a variety of other input/output devices such as a scanner, credit card reader, printer, mouse, touch screen, track pad, track ball, isopoint, voice recognition system, digital camera, electronic storage device reader (e.g., flash drive interface or magnetic media reader), etc. Although only one call center terminal 122 is illustrated in FIG. 1A, a plurality of call center terminals 122 may be connected to the network 130.

FIG. 1A also illustrates an Internet interface terminal 124 operatively coupled to the patient compliance facilitation system 100 via the network 130. As used herein, the term “Internet interface terminal” is hereby defined to mean any sort of terminal that allows a customer using the terminal to access the data network via the Internet, using an Internet communication protocol (e.g., hypertext transfer protocol, file transfer protocol, etc.), and capable of receiving and providing data associated with a prescription, a patient, or a customer. For example, an Internet interface terminal 124 may be disposed in a customer's home, a physician's office, or any other appropriate location. The Internet interface terminal 124, like the workstation 129, may include a display 186, a controller 170, a keyboard 190, as well as a variety of other input/output devices such as a scanner, credit card reader, printer, mouse, touch screen, track pad, track ball, isopoint, voice recognition system, digital camera, electronic storage device reader (e.g. flash drive interface or magnetic media reader), etc. Although only one Internet Interface terminal 124 is illustrated in FIG. 1A, a plurality of Internet interface terminals 124 may be connected to the network 130.

Those of ordinary skill in the art should recognize that there may be overlap between the various types of front-end components 102 employed in the patient compliance facilitation system 100. By way of example and not limitation, a call center terminal 122 located in a call center (not shown), or a client device 128 located at a pharmacy 110, may function as an Internet interface terminal 124, transmitting data to and receiving data from the patient record processing system 140 using an Internet communication protocol over the network 130. In such instance, a call center operator may use the call center terminal 122 to access the Internet over the network 130, and view or enter customer data via a web page. For this purpose, the patient record processing systems 140 may include a patient compliance facilitation web server 141. Those of ordinary skill in the art will appreciate that the patient compliance facilitation web server 141 may be a stand-alone server, or a software module implemented within the patient record processing system 140.

The various front-end equipment 102 may include a web browser client application 111. The patient compliance facilitation web server 141 transmits web pages to the various front-end equipment 126, 128 and 129 in response to URL requests received by the patient compliance facilitation web server 141 from the front-end equipment 102 over the network 130. The web pages sent to the front-end equipment 102 may include data pulled from the patient compliance record database 146, as well as data pulled from the legacy data stores 148. It should be noted that, while the current embodiment describes a web server 141 and a web browser client 111, each implementing the hyper-text transfer protocol, the web server 141 could implement any known protocol compatible with the client application 111 running on the front-end equipment 102 and adapted to the purpose of receiving and providing the necessary customer information via the network 130.

The processing systems 140 may further include a number of software applications. The various software applications are responsible for generating the data content to be included in the web pages sent from the patient compliance facilitation web server 141 to the various front-end equipment 102. The software applications may be executed on the same computer processor as the web server application 141, or on different computer processors. The patient compliance facilitation system 100 may also rely on software applications executed by legacy systems 147 when the legacy systems 147 include functionality that may be beneficial to incorporate into the patient compliance facilitation system 100. Patient compliance facilitation applications may include, by way of example and not limitation, a customer/prescription eligibility module 142 for determining whether a given prescription is eligible for alignment and whether any associated insurance company and any regulating body allow the processes required to align prescriptions, a prescription alignment module 143 for performing the calculations necessary to align prescriptions, a transaction cost module 144 for calculating the costs associated with aligning prescriptions, and a refill/inventory update module 145 for updating inventory requirements associated with aligning prescriptions. Those of ordinary skill in the art will appreciate that these modules may be implemented in any number of modules, and that their functions need not be divided as indicated in FIG. 1A.

Finally, the patient compliance facilitation back-end systems may include one or more administrator workstations 149. The administrator workstation 149 allows an unauthorized user to access the various applications running on the processing systems 140 to alter or adjust the operation of the patient compliance facilitation system 100. For example, a regulatory agency (e.g., a state government) may change its rules regarding prorating prescription copays. The administrator may then access the processing systems 140 via the administrator workstation 149 and alter rules active in the customer/prescription eligibility module 142, to reflect the changes in regulatory or third-party payor rules.

For purposes of implementing the patient compliance facilitation system 100, the primary point of contact with the customer is through the pharmacy. As used herein, the term “customer” may be, by way of example, a patient (i.e., the person named on the prescription), a guardian (e.g., the parent of a child named on the prescription), a care-giver (e.g., an in-home nurse who picks up prescriptions for one or more patients), etc. While term “customer” is used interchangeably with the term “patient,” in this specification, the term “customer” is used primarily so as to avoid confusion. Thus, a customer may be a patient (as where a person picks up his/her own prescriptions), but a customer may also be, by way of example, a parent picking up a prescription for a child, a husband picking up a prescription for his wife, a home-care nurse picking up a prescription for one or more patients, a care facility director picking up a prescription for one or more patients, etc. Also, as mentioned above, the pharmacy may be any of the channels through which the entity implementing the patient compliance facilitation system 100 serves its pharmacy customers. Thus, the pharmacy may be a retail drug store 112 in the customer's neighborhood (or any other drug store in a drug store chain), an on-line pharmacy 114, a mail-order pharmacy 116, a specialty pharmacy 118, or a hospital (not shown) affiliated with the entity implementing the customer compliance facilitation system 100. Whichever channel the customer chooses, the customer must typically interact with a pharmacist or other pharmacy staff (“pharmacy employee”) in order to have his or her prescriptions filled. The pharmacy employee filling the prescription will have access to one of the pharmacy workstations 129 or client terminal devices 128 and may invoke the customer compliance facilitation system 100 when he or she fills the customer's prescription. Alternatively, the customer compliance facilitation system 100 may be invoked automatically for each new prescription entered (e.g., by reminding the pharmacy employee to ask whether the customer would like to participate in the program) or by a broader system, such as a medication management system.

Generally, a prescription has associated with it a plurality of data. The plurality of data may include, but is not limited to: a date the prescription was written; a doctor who prescribed the medication; a name of the medication prescribed; an indication of whether a generic may be substituted for the prescribed medication; a number of days of medication to be dispensed; a number of refills prescribed; a first date on which the prescription was filled; a date on which the prescription was most recently filled; and a store at which it was most recently filled. The patient compliance facilitation system 100, using this information, may automatically determine the likelihood that an open prescription is currently and properly being used by the patient, as will be discussed in more detail below. The patient compliance facilitation system 100 may also use this information to determine an alignment date (or may otherwise receive an alignment date selection), on which one or more selected prescriptions will each be filled with a post-alignment day supply (e.g., each prescription being dispensed with a 60-day supply, a 90-day supply, etc). Aligning the plurality of selected prescriptions may require adjusting the day supply for one fill for each of one or more of the selected prescriptions, for example, by dispensing more of the medication (“overfilling”) or less of the medication (“underfilling”) such that the customer's supply of a first medication runs out at the same time as the supply of a second medication. An underfilled prescription is referred to herein as a reduced fill. Each reduced fill has an associated reduced fill date, on which the reduced fill is dispensed, and an associated reduced-fill day supply, indicating the number of days of medication dispensed.

A customer profile is created for every customer who purchases his/her medication at the pharmacy. The customer profile is a record that stores important information about the customer and the various pharmacy services that have been invoked on behalf of the customer. The customer profile may retrieve basic customer information, such as name, address, phone number, insurance group number, prescription history, etc., from the legacy systems data stores 148. The prescription history may include, but is not limited to, data such as: a list of the customer's prescriptions, and for each, the last fill date, the pre-alignment day supply, a number of refills remaining, etc. Additional data relating specifically to the customer's compliance facilitation program may be stored in the customer record database 146. The additional data may include, but is not limited to, data including: the date on which a patient opted in to the compliance facilitation program, the date on which a patient was discharged from a healthcare facility, the date that the patient should first be contact by pharmacy personnel, the questions that should be asked of the patient or customer upon first contact by the pharmacy personnel, the responses to those questions, the date that the patient should be contacted by pharmacy personnel for a pre-refill follow-up session, the questions that should be asked of the patient or customer upon follow-up by the pharmacy personnel, the responses to those follow-up questions, whether any answers to patient questions have triggered a need to contact a healthcare professional, and the date on which the patient prescriptions should be refilled.

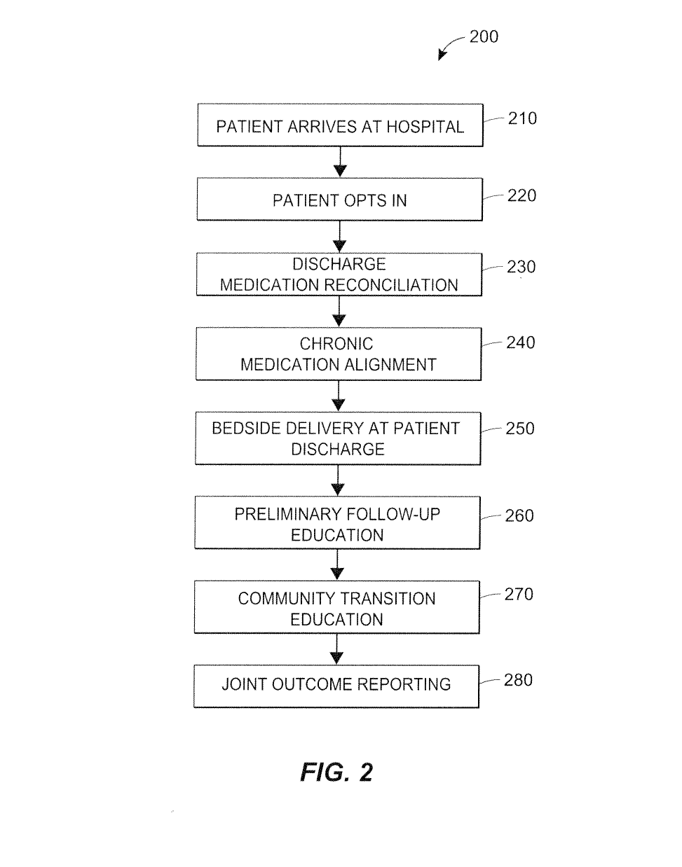

FIG. 2 shows an exemplary overview process 200 for facilitating patient compliance with instructions for proper use of prescription medication after discharge from a healthcare facility.

The exemplary process 200 begins when a patient arrives at and is admitted to a hospital or other healthcare facility (block 210). The patient may then be made aware of the compliance facilitation program. This may be accomplished in any number of suitable ways, including but not limited to: one-on-one counseling with an educator; a group session with an educator; media presentations via a television, computer, or other suitable device; pamphlets or other written educational materials; etc. Once the patient or customer has been educated on the offerings of the compliance facilitation program, the patient then “opts-in” (block 220). At this point, the patient may provide any information necessary to begin registration with the compliance facilitation program. A pharmacist, technician, or other qualified individual (“pharmacy employee”) may then collect all vital information from the patient or customer and enter this information into the compliance facilitation system 100.

After the patient information is collected and entered, discharge medication reconciliation may begin (block 230). Information regarding the patient's medical history, including any open prescriptions, if they exist, from any and all pharmacies or hospitals where a patient has previously filled a prescription, may be collected and consolidated. The medication history information may then be presented to a healthcare professional and cross-checked with the patient to assess baseline compliance with any open prescriptions, if they exist. A report of the cross-check, including a verified list of the patient's current prescriptions, may then be returned to the pharmacy employee. The pharmacy employee may then close any open prescriptions no longer in use by the patient, i.e. any open prescriptions not on the verified list of patient current prescriptions. The report may also include any new medications to be taken by the patient upon discharge from the healthcare facility.

After medical reconciliation is complete, medication alignment may begin (block 240). The pharmacy employee may gather the patient's current verified prescriptions and the patient discharge prescriptions and aligns all prescriptions such that the patient may refill all prescriptions on the same date. In other words, each of the patient's prescriptions may last for a pre-determined amount of time, the pre-determined amount of time being the same for each prescription.

Once the verified list of current prescriptions and the discharge prescriptions are aligned, some or all prescription medications may be delivered to the patient while the patient is preparing for discharge from the healthcare facility (block 250). The patient and/or caregiver may be offered counseling on the proper use of the medication, including, for example, known side-effects and issues that may be causes for concern. During counseling, the patient and/or caregiver may be encouraged to ask any questions or voice any concerns that remain unaddressed. After counseling, the patient may be discharged from the healthcare facility.

After a pre-determined amount of time, for example, a few days after the patient has been discharged from the healthcare facility, a pharmacy employee may be prompted to contact the patient and/or caregiver for preliminary follow-up education. As one of ordinary skill in the art will recognize, this pharmacy employee may be the same pharmacy employee from previous interactions with the patient or may be a different pharmacy employee. The pharmacy employee may ask the patient and/or caregiver a list of pre-determined or generated questions to assess the patient's compliance with the prescribed medications and post-discharge instructions (block 260). The patient and/or caregiver may also be encouraged to voice any comments or concerns regarding the patient's treatment, medication, or side-effects that may have materialized. If any of the patient and/or caregiver responses to the questions or any of the patient and/or caregiver comments or concerns trigger the need to contact a healthcare professional, the pharmacy employee may do so or may instruct the patient and/or caregiver to do so. In any event, the pharmacy employee may then provide instructions for the proper use of the remaining medication and will let the patient and/or caregiver know that they will be contacted again at a time closer to the refill date for all prescription medication.

At another pre-determined amount of time, for example a few days before the refill date for the patient prescriptions, a pharmacy employee (the same pharmacy employee or a different pharmacy employee) may again be prompted to contact the patient and/or caregiver for community transition education (block 270). The pharmacy employee may ask the patient and/or caregiver a list of pre-determined or generated questions to assess the patient's continued compliance with the prescribed medications and post-discharge instruction. The patient and/or caregiver may again be encouraged to voice any comments or concerns regarding the patient's treatment, medication, or side-effects that may have materialized. Again, if any of the patient and/or caregiver responses to the questions or any of the patient and/or caregiver comments or concerns trigger the need to contact a healthcare professional, the pharmacy employee may be prompted to do so or may instruct the patient and/or caregiver to do so. Finally, the pharmacy employee may discuss where the patient would like their medications refilled. Upon learning of said pharmacy, the pharmacy employee may then transfer all open prescriptions to the patient's preferred refill site

Finally the pharmacy may participate in joint outcome reporting (block 280). The pharmacy will generate one or more reports based on all responses elicited from the preliminary follow-up education, the community transition education, and any other interaction that the pharmacy has had with the patient and/or caregiver since patient discharge. The report may then be combined with hospital re-admission information to analyze the success of the program and pertinent measurements, including but not limited to the effect on patient re-admission rates and hospital satisfaction ratings.

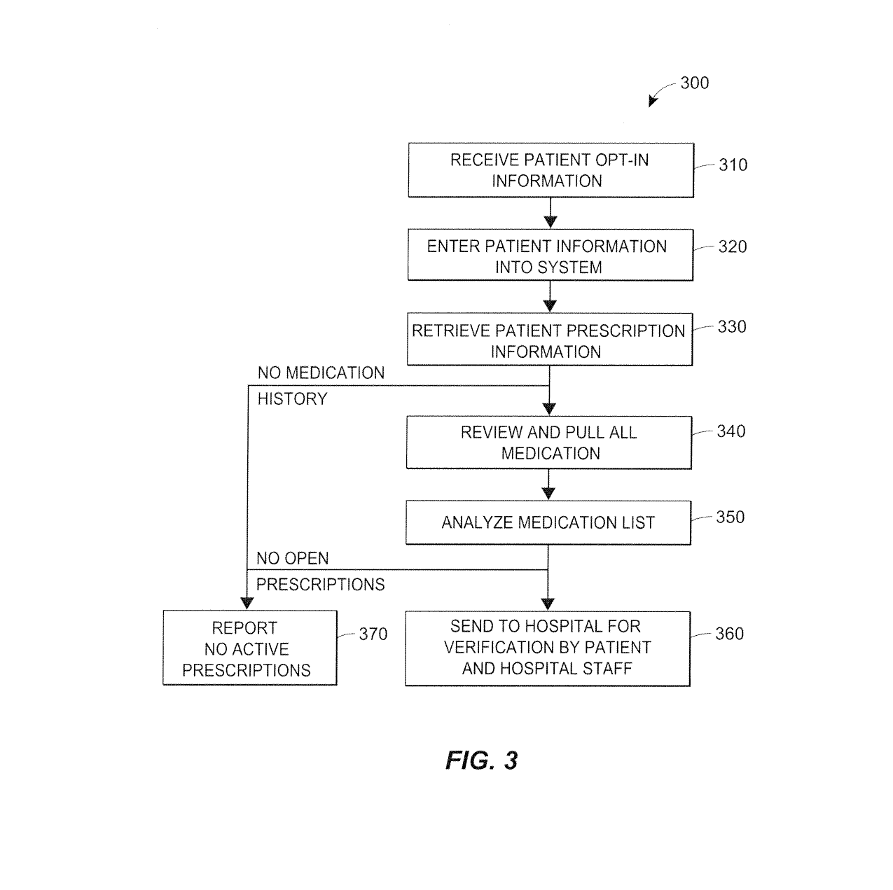

As mentioned above, once a patient “opts in” to the program, medical reconciliation may begin. An exemplary discharge medication reconciliation routine is described in further detail in FIG. 3, which is a detailed flow chart of an exemplary discharge medication reconciliation algorithm 300. First, the pharmacy may receive the patient “opt-in” information (block 310). This patient “opt-in” information may include, but is not limited to: patient's first and last name, patient's date of birth, patient's gender, patient's zip code, etc.

The pharmacy employee may then enters the patient “opt-in” information into the patient compliance facilitation system 100 (block 320). For example, the pharmacy employee may enter the patient “opt-in” information into the compliance facilitation system 100 via one of the pharmacy workstations 129. Alternatively, the patient “opt-in” information may be received directly from the healthcare facility where the patient has been admitted via the Internet or some other suitable electronic method. Still further, the patient “opt-in” information may be received directly from the patient and/or customer via any number of personal computing devices, such as a computer, a cellular phone, a personal digital assistant, a tablet computer, or any other device that may remotely or directly connect to the compliance facilitation system 100. Once the patient “opt-in” information is entered into the compliance facilitation system 100, the patient “opt-in” information may be sent, via the network 130, to the processing system 140. A patient record may then be created in the database 146 and/or the legacy data stores 148, based on the patient “opt-in” information.

After the patient record is created in the database 146 and/or the legacy data stores 148, the pharmacy employee may use the system 100 to retrieve the patient's medication history (block 330). This information may include, but is not limited to, any current or previous prescriptions associated with the patient in any pharmacy across the country or the world. The patient's medication history may be collected, for example, by using a portal into a central pharmacy claims and transactions database (not shown) and the patient's “opt-in” information. The central pharmacy claims and transactions database may provide the system 100 with raw data of every transaction a patient or customer initiated concerning prescription medication. The system 100 may then generate a patient profile associated with the patient record in the database 146 based on the patient's medication history. The database 146 containing the patient profile is available to a pharmacy employee through any suitable equipment connected to the network 130 including, for example, terminals 128 or workstation 129.

If the patient profile shows that there is no medication history associated with the patient, then the pharmacy employee may report to the healthcare professional that there are no active prescriptions associated with the patient (block 370).

Alternatively, if the patient profiles shows that there is a medication history associated with the patient, then the pharmacy employee may review the entire patient profile and pulls all medication the patient may be currently taking (block 340). The pharmacy employee may determine which medication the patient may be currently taking in a number of different ways. The pharmacy employee may determine which medication the patient may be currently taking based on, for example, the date of the last refill of a particular medication. The pharmacy employee may alternatively determine which medication the patient may be currently taking based on the quantity provided to the patient at the date of the last refill of a particular medication. Still further, the system 100 may generate recommendations for the pharmacy employee as to which medications the patient may likely still be using, based on the patient's medication history as provided by the central pharmacy claims and transactions database. In any event, the pharmacy employee should include all medications that are potentially a part of the patient's current regimen, assuming a lack of compliance with any instructions provided for taking any one or more of the medications. If a pharmacy employee decides that a patient is not taking one or more of the prescriptions identified in the patient profile, then the pharmacy employee should exclude those one or more medications from the potentially active medications. The pharmacy employee then compiles these potentially active medications to create a list of active prescriptions associated with the patient.

If there are no potentially active medications on the list of active prescriptions associated with the patient, then the pharmacy employee may report that there are no active prescriptions associated with the patient (block 370).

Alternatively, if there are potentially active medications on the list of active prescriptions associated with the patient, then the pharmacy employee may then analyze the list of active prescriptions associated with the patient (block 350). The analysis may include any potential interactions or contraindications that may occur between or among medications on the list of active prescriptions associated with the patient. Interactions or contraindications may be based, for example, on the dosage amounts of two or more medications that may have adverse effects when taken simultaneously. The analysis may also include, for example, a determination as to whether any one or more of the active medications have been discontinued or whether new side-effects or warnings have been issued for any one or more of the active medications.

Once the pharmacy employee has analyzed the list of active prescriptions associated with the patient, the system 100 may generate a list of active prescriptions associated with the patient. The list of active prescriptions may then be delivered to a healthcare professional treating the patient (block 360). As will be recognized by one of ordinary skill in the art, the list of active prescriptions may be delivered to the healthcare professional in any number of ways, including but not limited to: electronically, via telephone, via the Internet, via hand-delivery, etc.

The healthcare professional may then work with the patient and/or caregiver to determine which of the medications on the list of active prescriptions the patient is currently taking. Once the healthcare professional has determined which prescriptions on the list of active prescriptions are appropriate for the patient to continue taking, the healthcare professional may create a verified list of patient current prescriptions for the patient. If the healthcare professional decides that the patient should continue to take all medications on the list of active prescriptions, then the verified list of patient current prescriptions may be the same as the list of active prescriptions. However, if the healthcare professional decides that the patient should discontinue use of one or more of the medications on the list of active prescriptions, then the verified list of patient current prescriptions may be different from the list of active prescriptions. It is possible that the healthcare professional may decide that the patient should discontinue the use of all medications on the list of active prescriptions, in which case there will be no medications on the verified list of patient current prescriptions. In any event, the hospital may keep one copy of the verified list of patient current prescriptions for the patient's file and may send another copy back to the pharmacy.

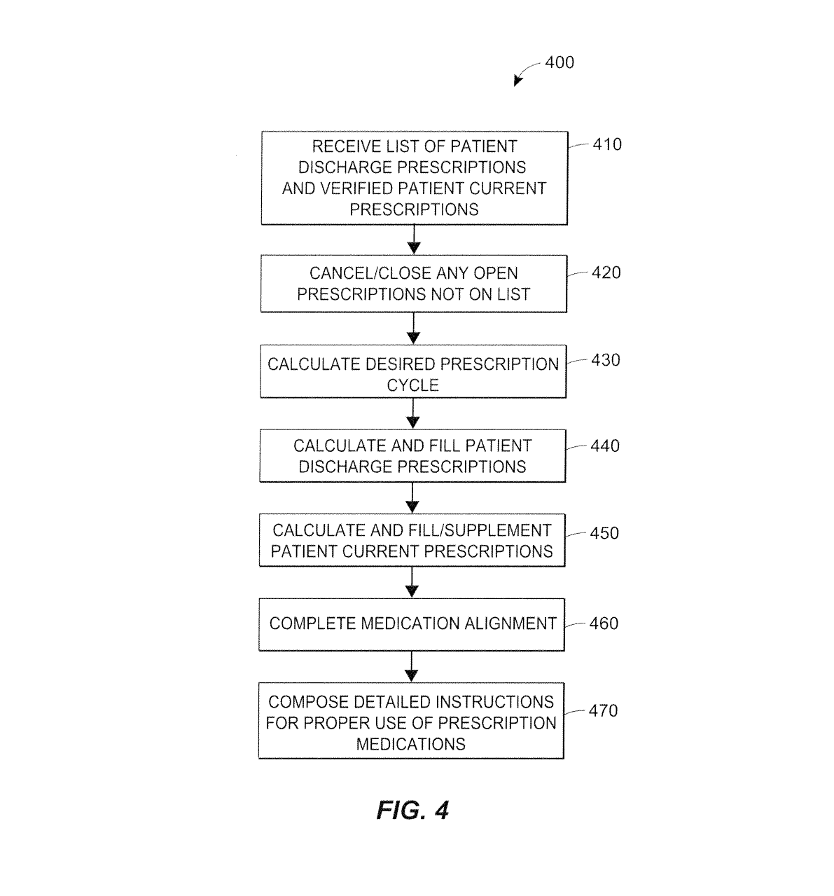

After the discharge medication reconciliation routine is executed, the pharmacy employee may begin the medication alignment routine. FIG. 4 is an exemplary algorithm of the medication alignment routine 400. The pharmacy employee may receive the verified list of patient current prescriptions, if any, associated with the patient. In addition, the pharmacy employee may also receive a list of medications that the patient should take after discharge from the healthcare facility (a list of patient discharge prescriptions) to the pharmacy (block 410).

Following receipt of the medication lists, the pharmacy employee may compare the list of patient discharge prescriptions and the verified list of patient current prescriptions (block 420). The pharmacy employee may then use the system 100 to cancel any open prescriptions in the patient profile that do not appear on either the list of patient discharge prescriptions or the verified list of patient current prescriptions. This may be accomplished for local prescriptions (i.e. those prescriptions that were filled at the particular pharmacy or pharmacy chain where the current prescriptions are being filled) simply by cancelling the prescription internally. However, if there are open prescriptions that are not housed locally by the particular pharmacy or pharmacy chain where the current prescriptions are being filled, the pharmacy employee may need to cancel those prescriptions by contacting the pharmacy where the open prescription was previously filled. The pharmacy employee may then update the patient's profile in the system 100 to indicate that the verified list of patient current prescriptions and the list of patient discharge prescriptions encompass the entire list of prescription medications that the patient currently uses.

The pharmacy employee may then calculate a desirable time cycle for prescription alignment by calculating a next fill date to occur after a pre-determined amount of time (block 430). This calculation may depend on the patient profile in addition to a number of factors, such as the type of medication prescribed by the healthcare provider, the dosage of the medication prescribed by the healthcare provider, the frequency with which a healthcare provider may like to check up on a patient, readmission rates for the particular ailment associated with the patient, side effects associated with the medication, the amount of time a medication may take to become effective, etc. Alternatively, the pre-determined amount of time may be indicated by the healthcare provider. Still further, the pre-determined amount of time may be calculated and recommended by the system 100 based on the patient profile and those factors mentioned above. By way of example and not limitation, the pre-determined amount of time used in this example will be 30 days.

The pharmacy employee may then calculate the amount of medication required to supplement the medications on the verified list of patient current prescriptions for the pre-determined amount of time, i.e. 30 days (block 440). For example, if the last fill date for a particular prescription was 15 days ago, and on that date the patient received a 30-day supply of the medication, then the patient has 15 days of medication remaining. The patient will need an additional 15-day supply to get them to align their medication for that particular prescription to the 30-day supply. However, the pharmacy employee should also take the duration of the patient's stay in the hospital into account when supplementing prescriptions. This is because patients do not take medication from their own supply while admitted in the hospital. Using the example above, if a last fill date for a particular prescription was 15 days ago and the patient received a 30-day supply of the medication, then the patient has a 15-day supply of the medication remaining. However, if the patient spent five days in the hospital, then the patient has received medication from the hospital for five days rather than taking from their own supply. The patient will then need an additional ten day supply of that particular medication to align their medication with the discharge medication. If the patient is in the hospital for more than 30 days, for example for 40 days, and the patient has a 15-day supply remaining at home, then the pharmacy employee should fill the prescription with a five-day supply, thus lasting the patient until the end of the next 30-day period. Alternatively, the system 100 may automatically calculate the amount of medication required to supplement the medications on the verified list of patient current prescriptions for the pre-determined amount of time, given inputs from the healthcare professional and/or the pharmacy employee or any other qualified individual.

The pharmacy employee may use a similar calculation to determine the amount of discharge medication required to supply the patient for the pre-determined amount of time (block 450). For example, if the pre-determined amount of time is 30 days, and the patient was in the hospital for five days, then the pharmacy employee should fill the prescription for each of the discharge medications such that the supply will last the patient for 25 days. If the patient did not spend any time in the hospital, then the pharmacy employee should fill the prescription for each of the discharge medications with the full 30-day supply. If the patient is in the hospital for more than 30 days, for example for 40 days, then the pharmacy employee should fill the prescription with a 20-day supply, thus lasting the patient until the end of the next 30-day period. Alternatively, the system 100 may automatically calculate the amount of medication required to supply the patient with discharge medication for the pre-determined amount of time, given inputs from the healthcare professional and/or the pharmacy employee or any other qualified individual.

Once the next fill date has been calculated and the medication supplement amounts have been calculated, the pharmacy employee may begin the prescription alignment process (block 460). The goal of the prescription alignment process is to facilitate a customer's refilling of prescriptions by allowing all prescriptions to be refilled on the same date and in the same cycle. For example, rather than refilling Prescription A once a week, Prescription B every 20 days, and Prescription C every two months, a customer may, instead, refill Prescriptions A, B, and C once monthly on the same 30-day cycle, thus requiring fewer trips to the pharmacy and allowing less room for confusion or error. Prescription alignment may be accomplished in any number of known ways, including but not limited to the method and system for prescription alignment described in US Patent Application No. 2009/0030719 A1, which is incorporated by reference fully herein.

Once all medications on the list of patient discharge medications and the verified list of patient current prescriptions are properly filled and aligned, the pharmacy employee may compose detailed instructions for the use of the medication included in the patient discharge medications and verified patient current prescriptions (block 470). Alternatively, these detailed instructions may be composed automatically by the system 100 based on information about the medications, dosages, the particular patient, and any special indications given by a healthcare provider, some or all of which may be entered into and stored in the database 146. Still further, detailed instructions for proper use of the prescription medication may be specified by the healthcare provider and entered into the system 100, for example, either by a pharmacy employee or electronically via the Internet.

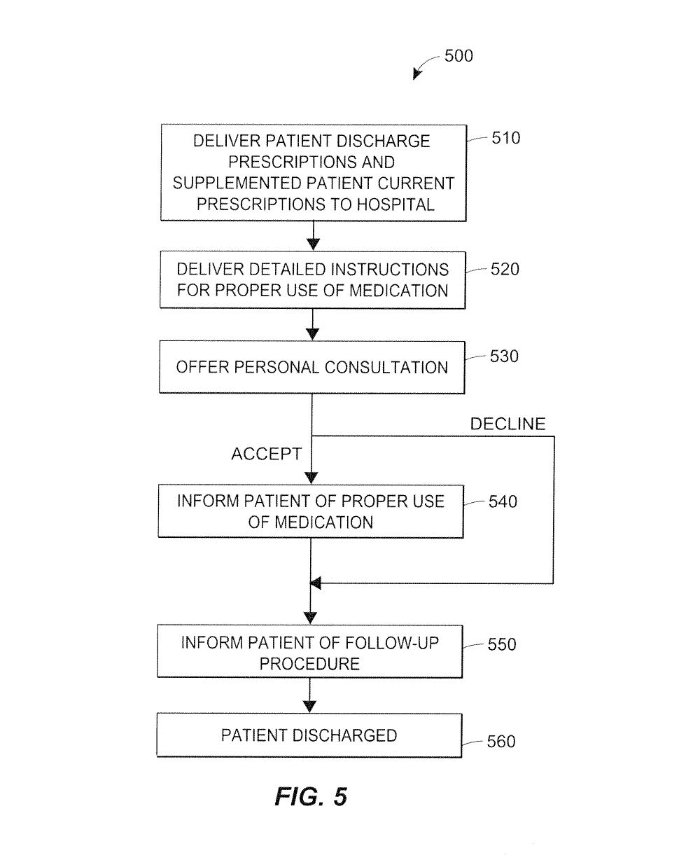

On the date of patient discharge from the healthcare facility, the pharmacy may initiate the bedside delivery and consultation routine. An exemplary bedside delivery and consultation algorithm 500 is shown in FIG. 5. With reference to FIG. 5, the pharmacy may send all discharge medication to the healthcare facility, including any medication included on the list of patient discharge prescriptions or any medication supplemented based on the verified list of patient current prescriptions (block 510). The pharmacy may then send detailed instructions for the proper use of the discharge medication (block 520). Either the discharge medication, the detailed instructions, or both may be physically delivered to the healthcare facility via hand-delivery. Alternatively, the system 100 may automatically send one or more prescriptions to the healthcare facility to be filled by a pharmacy located in the healthcare facility. Further still, the detailed instructions may be sent electronically to the healthcare facility or communicated over the telephone or any other suitable device to an employee or voicemail system at the healthcare facility. One of ordinary skill in the art will appreciate that there are many method by which this delivery may occur, including via the Internet, voice-over-Internet-protocol, telephone, email, in-person delivery, video conference, etc.

The patient and/or caregiver may be offered a personal consultation to review the proper use of the discharge medication more thoroughly and in a one-on-one, personal environment (block 530). If the patient accepts the consultation (block 540), then the patient may be contacted by a pharmacy employee or other qualified person through any number of suitable methods, including but not limited to: via telephone, in person, web chat, voice-over-internet, pre-taped presentation, etc. If the patient declines the consultation, then the patient will not be contacted.

Regardless of whether the patient and/or caregiver accepts or declines the personal consultation, the pharmacy employee or other suitable person may remind the patient of the follow-up procedures involved in the patient compliance facilitation program (block 550). The pharmacy employee or other suitable person may further remind the patient and/or caregiver that the program includes a first follow-up contact close to the date of discharge and a second follow-up contact close to the date of first refill of their prescriptions.

Ultimately, the patient is discharged from the healthcare facility (block 560). At that time, the system may automatically enter the date of discharge into the system 100. Alternatively, a pharmacy employee may manually enter the date of discharge into the patient profile in the patient compliance facilitation system 100. From this date and the date of first refill, the system 100 may determine a date for the first follow-up contact. For example, if the date of discharge is August 1st, then the date for the first follow-up contact may be August 3rd or August 4th, as appropriate for the particular patient.

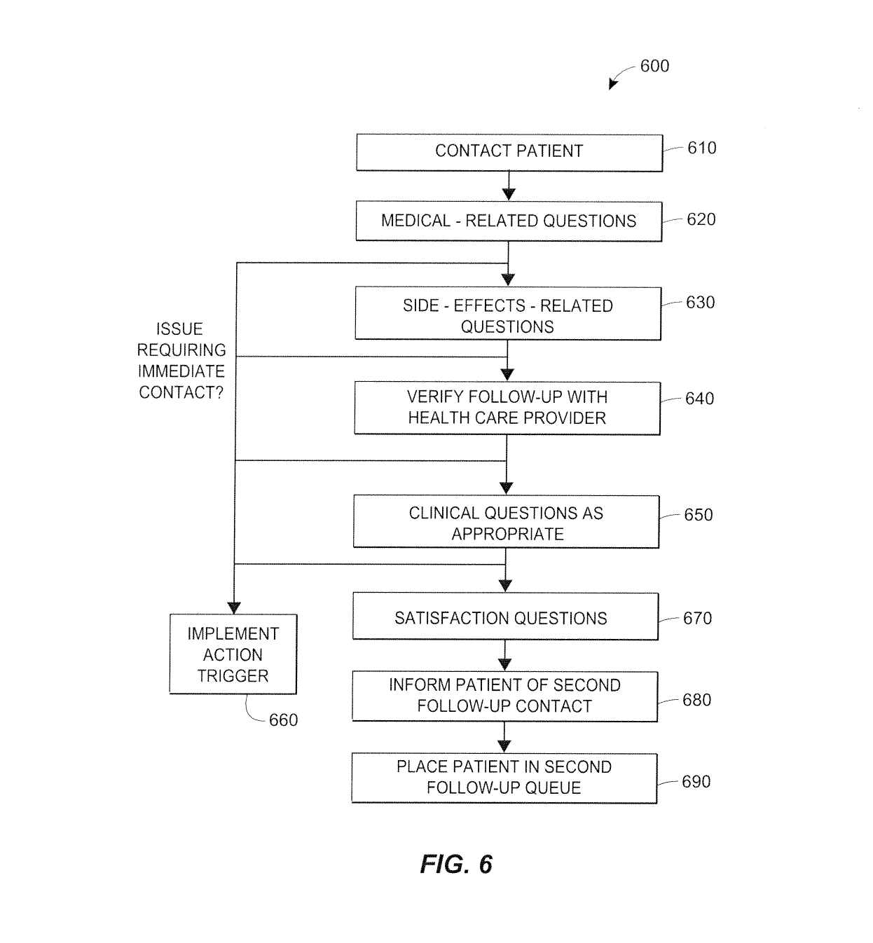

On the date for the first follow-up contact (in this example, August 3 or August 4), the pharmacy may initiate preliminary follow-up education. A detailed depiction of an exemplary preliminary follow-up education algorithm 600 is shown in FIG. 6. To begin, a pharmacy employee may be prompted by the system 100 to initiate preliminary follow-up education (block 610). The pharmacy employee may initiate this contact using any number of suitable methods, including but not limited to: in-person, via telephone, via web chat, via web survey, via email survey, via written questionnaire, etc.

The pharmacy employee may ask the patient and/or caregiver medical related questions (block 620). The system 100 may automatically generate a list of questions for the pharmacy employee to ask the patient. These questions may be based on known information, such as the patient's profile, which includes the patient's medical history and the list of medications that the patient is currently taking, and a database of known medical issues that have presented themselves in other patients following similar health conditions. Alternatively, the pharmacy employee may enter a list of questions to ask the patient manually into the system 100. The system 100 may prompt the pharmacy employee to ask each question and then may prompt the pharmacy employee to record the patient response to each question. If any of the patient responses to the medical questions indicate that an issue requiring a healthcare professional may have occurred, the system 100 may prompt the pharmacy employee to contact a healthcare professional (block 660). Otherwise, the pharmacy employee will proceed to the next set of questions without contacting a healthcare professional.

The pharmacy employee may also ask the patient and/or caregiver side effect related questions (block 630). The system 100 generates a list of questions for the pharmacy employee to ask the patient. These questions may be based on known information, such as the patient's profile, which includes the patient's medical history and the list of medications that the patient is currently taking, and a database of known side effects that have presented themselves in other patients who have taken similar mediation. Alternatively, the pharmacy employee may enter a list of questions to ask the patient manually into the system 100. The system 100 will prompt the pharmacy employee to ask each question and then to record the patient response to each question. If any of the patient responses to the side effects questions indicate that an issue requiring a healthcare professional may have occurred, the system 100 will prompt the pharmacy employee to contact a healthcare professional (block 660). Otherwise, the pharmacy employee will proceed to the next set of questions.

In addition, the pharmacy employee may ask the patient and/or caregiver about compliance with healthcare provider follow-up procedures (block 640). The system 100 generates a list of questions for the pharmacy employee to ask the patient. These questions may be based on known information, such as the patient's profile, which includes the patient's medical history and the list of medications that the patient is currently taking, and a database of known healthcare provider follow-up procedures associated with a particular healthcare provider or healthcare facility. Alternatively, the pharmacy employee may enter a list of questions to ask the patient manually into the system 100. The system 100 will prompt the pharmacy employee to ask each question and then to record the patient response to each question. If any of the patient responses to the follow-up procedure questions indicate that an issue requiring a healthcare professional may have occurred, the system 100 will prompt the pharmacy employee to contact a healthcare professional (block 660). Otherwise, the pharmacy employee will proceed to the next set of questions.

The pharmacy employee may also ask the patient and/or caregiver clinical questions, as appropriate (block 650). The system 100 generates a list of questions for the pharmacy employee to ask the patient. These questions may be based on known information, such as the patient's profile, which includes the patient's medical history and the list of medications that the patient is currently taking, and a database of known clinical concerns that may present themselves following discharge from a healthcare facility. Alternatively, the pharmacy employee may enter a list of questions to ask the patient manually into the system 100. The system 100 will prompt the pharmacy employee to ask each question and then to record the patient response to each question. If any of the patient responses to the clinical questions indicate that an issue requiring a healthcare professional may have occurred, the system 100 will prompt the pharmacy employee to contact a healthcare professional (block 660). Otherwise, the pharmacy employee will proceed to the next set of questions.

Still further, the pharmacy employee may ask the patient and/or caregiver about patient and/or caregiver satisfaction with the particular healthcare services, as appropriate (block 670). The system 100 generates a list of questions for the pharmacy employee to ask the patient. These questions may be based on known information, such as the patient's profile, which includes the patient's medical history and the list of medications that the patient is currently taking, and a database of satisfaction survey questions, the responses to which may be useful for improving the healthcare services. Alternatively, the pharmacy employee may enter a list of questions to ask the patient manually into the system 100. The system 100 may prompt the pharmacy employee to ask each question and then to record the patient response to each question. The system 100 may then generate a report based on the responses to each question. This report may include any number of fields, such as: any warning signs that the patient is not fully complying with post-discharge instructions; any side effects that the patient is experiencing; any dissatisfaction the patient may have had with his/her treatment at the healthcare facility; any dissatisfaction the patient may have had regarding his/her treatment by any one or more healthcare professionals; any improvements that the patient has seen as a result of any treatment and/or medication received at the healthcare facility; any additional questions that the patient may have for the healthcare provider; any additional concerns that the patient may have concerning his/her medications and/or treatment.

The preliminary follow-up education routine 600 may then cause the system 100 to prompt the pharmacy employee to inform the patient and/or caregiver that they should expect a second follow-up contact at a date closer to the date of their first refill for their prescriptions (block 680).

The system 100 may then calculate a date for the second follow-up contact based on the date of the first refill for the prescriptions and any concerns that may have been raised during the first follow-up contact (block 690). For example, if the date of the first refill is scheduled for August 30th, and no concerns have been raised during the first-follow up contact, then the second follow-up contact may be scheduled for August 27th. However, if the date of the first refill is scheduled for August 30th and there were some concerns about compliance or side-effects raised during the first follow-up contact, then the second follow-up contact may be scheduled for sooner, perhaps August 20th. Alternatively, a date for the second follow-up contact may have already been determined at patient discharge and entered into the system 100.

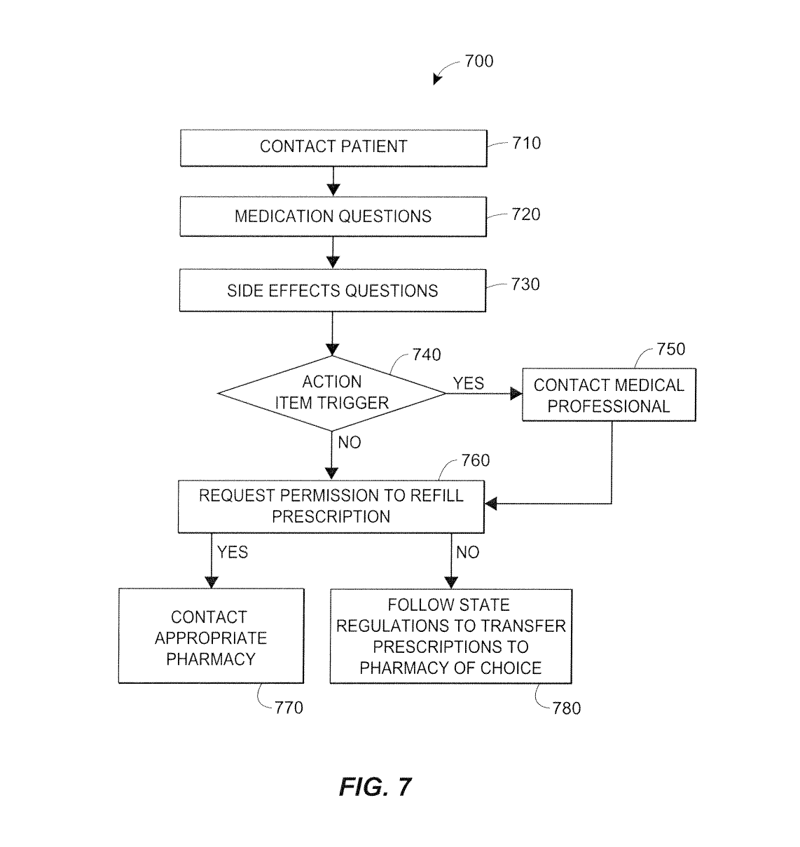

Regardless of the date chosen for the second follow-up contact, the system 100 may prompt the pharmacy employee to initiate a second follow-up contact on the calculated date. A detailed depiction of an exemplary community transition contact routine 700 is shown in FIG. 7. First, the pharmacy employee may be prompted by the system 100 to initiate preliminary follow-up education (block 710). The pharmacy employee may initiate this contact using any number of suitable methods, including but not limited to: in-person, via telephone, via web chat, via web survey, via email survey, via written questionnaire, etc.

The pharmacy employee may ask the patient and/or caregiver medication related questions (block 720). The system 100 generates a list of questions for the pharmacy employee to ask the patient. These questions may be based on known information, such as the patient's profile, which includes the patient's medical history and the list of medications that the patient is currently taking, and a database of known medical issues that have presented themselves in other patients following similar hospital or health care facility stays. Alternatively, the pharmacy employee may enter a list of questions to ask the patient manually into the system 100. The system 100 will prompt the pharmacy employee to ask each question and then to record the patient response to each question.

The pharmacy employee may similarly ask the patient and/or caregiver side effect related questions (block 730). The system 100 generates a list of questions for the pharmacy employee to ask the patient. These questions may be based on known information, such as the patient's profile, which includes the patient's medical history and the list of medications that the patient is currently taking, and a database of known side effects that have presented themselves in other patients who have taken similar mediation. Alternatively, the pharmacy employee may enter a list of questions to ask the patient manually into the system 100. The system 100 will prompt the pharmacy employee to ask each question and then to record the patient response to each question.

If it is determined that any of the patient responses to the medication questions or the side effects questions indicate that an issue requiring a healthcare professional may have occurred (block 740), the system 100 may prompt the pharmacy employee to contact a healthcare professional (block 750). Regardless, the system 100 may then generate a report based on the responses to each question. As with the report generated in the preliminary follow-up education routine, this second report may include any number of fields, such as: any warning signs that the patient is not fully complying with post-discharge instructions; any side effects that the patient is experiencing; any dissatisfaction the patient may have had with his/her treatment at the healthcare facility; any dissatisfaction the patient may have had regarding his/her treatment by any one or more healthcare professionals; any improvements that the patient has seen as a result of any treatment and/or medication received at the healthcare facility; any additional questions that the patient may have for the healthcare provider; any additional concerns that the patient may have concerning his/her medications and/or treatment.

The system 100 may prompt also the pharmacy employee to ask the patient and/or caregiver about where the patient's prescriptions should be refilled on the refill date (760). If the patient and/or caregiver indicates that the prescriptions should be refilled by the pharmacy initiating contact, then the pharmacy employee should send the appropriate request to the retail pharmacy 112, online pharmacy 114, mail order pharmacy 116, specialty pharmacy 118, or hospital (not shown) indicated by the patient and/or caregiver (block 770). If the patient and/or caregiver decline the offer to refill by the pharmacy, instead preferring refilling at a different pharmacy, then the pharmacy employee should follow state regulations to transfer the patient prescriptions to the patient's pharmacy of choice (block 780).

After the second follow-up contact has been completed, the pharmacy may participate in joint outcome reporting. The purpose of the joint outcome reporting is to quantify and qualify the participation of the patient and the pharmacy in the patient compliance facilitation program. For example, the joint outcome report may indicate, statistically, at what point after discharge a patient may have trouble complying with pharmacy employee or healthcare provider instructions. As another example, the joint outcome report may indicate at what point a patient is most likely to suffer side effects from a certain medication. This information, combined with re-admission information, will help to analyze the success of post-discharge strategies and the effect on re-admission and satisfaction rates.

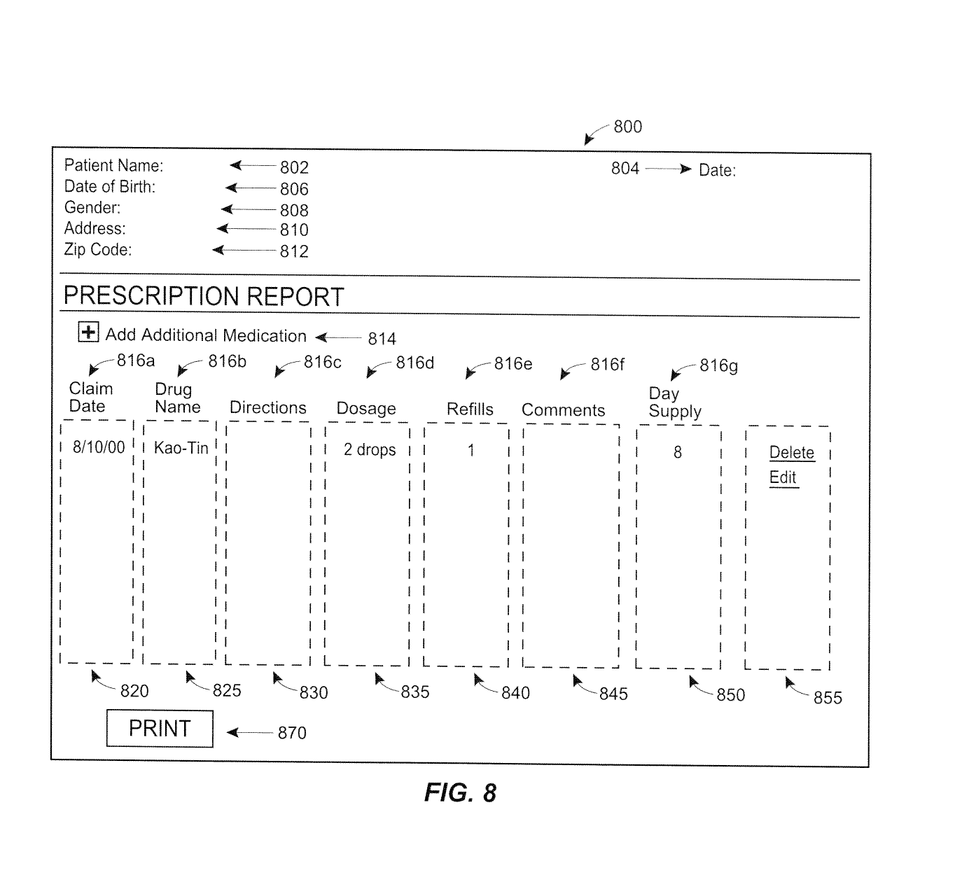

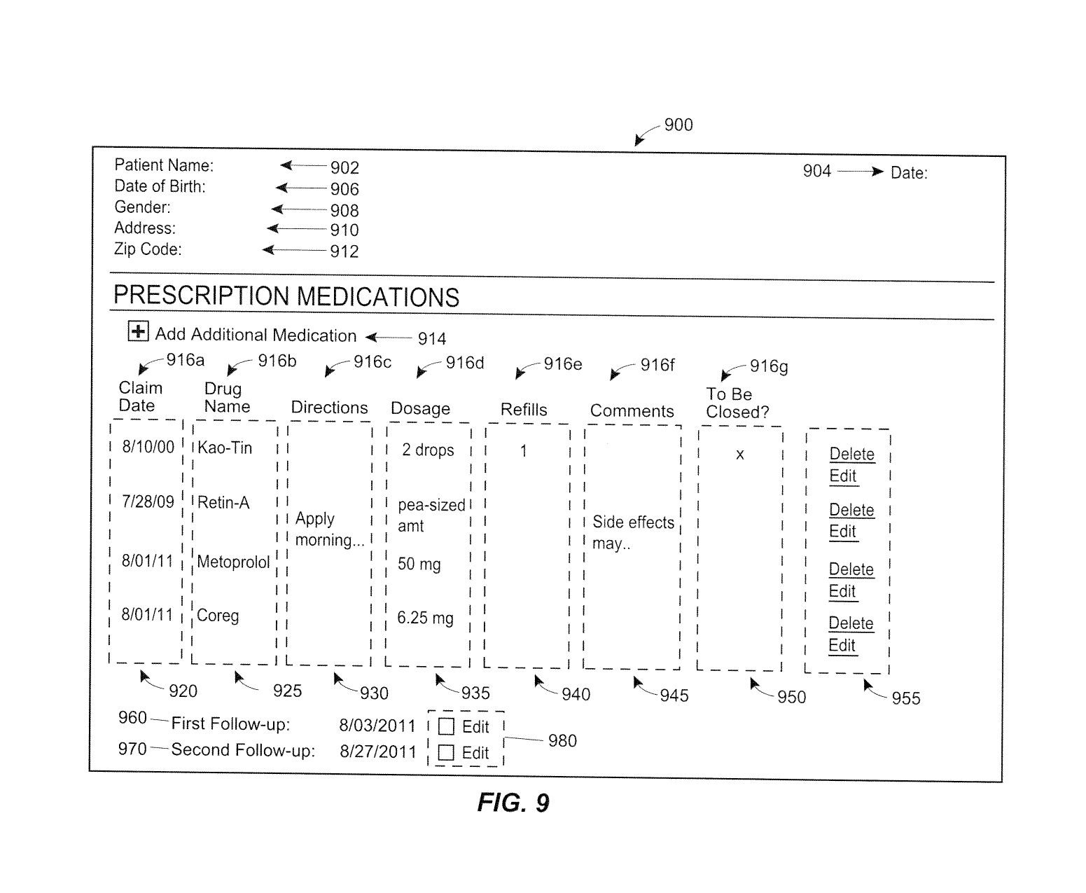

FIGS. 8 and 9 depict an exemplary embodiment of a user-interface 800-900 for entering and displaying information related to a patient compliance facilitation system 100. A first page or screen 800 displays a prescription report, which is a list of open prescriptions associated with the patient that may or may not be currently used by the patient. The prescription report is generated as a result of a query from a database, such as, for example, a central pharmacy claims and transactions database. The first page 800 includes an indication 802 of the customer name, an indication 804 of the current date, an indication 806 of the patient's date of birth, and indication 808 of the patient's gender, an indication 810 of the patient's address, and an indication 812 of the patient's zip code. The first page or screen 800 also displays an indication of an option to “add additional medication” 814. By using the “add additional medication” option 814, the pharmacy employee may add additional fields associated with additional prescription medications to the prescription report.

A plurality of column headings 816a-816g indicate what additional data is displayed on the page. In one exemplary embodiment, illustrated in FIG. 8, the column headings include a claim date 816a, the name of the drug 816b, directions for taking the particular medication 816c, dosage indications 816d, a number of refills remaining 816e, any pharmacy employee comments 816f, and a day supply 816g. Below the column headings 816a-816g, the user interface displays the associated data for each of a plurality of prescriptions in tabular format, with data for each prescription associated with a single row of the table. For example, a plurality of prescription claim dates 820 are displayed below the claim date heading 816a and a plurality of drug names 825 are displayed below the drug name heading 816b. In a similar manner, a plurality of directions 830 is displayed below the directions heading 816c, a plurality of dosages 835 are displayed below the dosage heading 816d, a plurality of refills 840 are displayed below the refill heading 816e, a plurality of comments 845 are displayed below the comment heading 816f, and a plurality of day supplies 850 are displayed below the day supply heading 816g.

Additionally, the first page 800 of the user-interface 800-900 includes a plurality of “edit” and “delete” links 855, with one set of links associated with each displayed prescription. Using these links, a pharmacy employee may choose to “edit” any of the fields associated with one of the displayed prescriptions. For example, a pharmacy employee may desire to change the dosage amount for a given prescription. The pharmacy employee need only click on the “edit” link in the plurality of “edit” and “delete” links 855 associated with the particular prescription in order to edit the dosage field. Alternatively, a pharmacy employee may choose to delete an entire prescription from the list of prescriptions. In that case, a pharmacy employee need only click on the “delete” link in the plurality of “edit” and “delete” links 855 associated with the particular prescription in order to delete the entire record. Once deleted, the prescription will no longer be displayed on the first page 800 of the user-interface 800-900. The first page 800 of the user-interface 800-900 also includes a print button 870.

Referring now to FIG. 9, a second page 900 of the user-interface 800-900 provides the user with information related to the open prescriptions no longer used by the patient, the verified patient current prescriptions, the patient discharge prescriptions, directions detailing proper use of the prescriptions, and patient contact dates for post-discharge education and follow-up. The second page 900 includes an indication 902 of the customer name, an indication 904 of the current date, an indication 906 of the patient's date of birth, and indication 908 of the patient's gender, an indication 910 of the patient's address, and an indication 912 of the patient's zip code. The second page or screen 900 also displays an indication of an option to “add additional medication” 914. By using the “add additional medication” option 914, the pharmacy employee may add additional fields associated with additional prescription medications to the patient medications.

A plurality of column headings 916a-916g indicate what additional data is displayed on the page. In one exemplary embodiment, illustrated in FIG. 9, the column headings include a claim date 916a, the name of the drug 916b, directions for taking the particular medication 916c, dosage indications 916d, a number of refills remaining 916e, any pharmacy employee comments 916f, and whether the prescription should be closed 916g. Below the column headings 916a-916g, the user interface displays the associated data for each of a plurality of prescriptions in tabular format, with data for each prescription associated with a single row of the table. For example, a plurality of prescription claim dates 920 are displayed below the claim date heading 916a and a plurality of drug names 925 are displayed below the drug name heading 916b. In a similar manner, a plurality of directions 930 are displayed below the directions heading 916c, a plurality of dosages 935 are displayed below the dosage heading 916d, a plurality of refills 940 are displayed below the refill heading 916e, a plurality of comments 945 are displayed below the comment heading 916f, and a plurality indications as to whether the particular prescription should be closed 950 are displayed below the “To be Closed?” heading 916g.

Additionally, the second page 900 of the user-interface 800-900 includes a plurality of “edit” and “delete” links 955, with one set of links associated with each displayed prescription. Using these links, a pharmacy employee may choose to “edit” any of the fields associated with one of the displayed prescriptions. For example, a pharmacy employee may desire to change the dosage amount for a given prescription. The pharmacy employee need only click on the “edit” link in the plurality of “edit” and “delete” links 955 associated with the particular prescription in order to edit the dosage field. Alternatively, a pharmacy employee may choose to delete an entire prescription from the list of prescriptions. In that case, a pharmacy employee need only click on the “delete” link in the plurality of “edit” and “delete” links 955 associated with the particular prescription in order to delete the entire record. Once deleted, the prescription will no longer be displayed on the second page 900 of the user-interface 800-900.

Still further, the second page 900 of the user-interface 800-900 includes an indication 960 of a first follow-up date on which the patient should be contacted and an indication 970 of a second follow-up date on which the patient should be contacted. Each of these dates is editable using the plurality of “edit” options 980.

The exemplary user interface 800-900 illustrated in FIGS. 8 and 9 need not comprise precisely two pages or screens. The information displayed may be formatted differently than in the illustrative figures, such that all of the information may be displayed on a single screen. For example, the prescription report and the patient medications may be displayed side-by-side on the same screen for comparison. Alternatively, the information may be displayed in three or more screens. Those of ordinary skill in the art will recognize multiple configurations that may fit the needs of the current system, and the exemplary embodiments illustrated and described above are not intended to limit the scope of the present invention.

Those of ordinary skill in the art will recognize that the exemplary user-interface depicted in FIGS. 8-9 may take the form of a web page, transmitted over the network 130 (e.g., the Internet) from the processing system 140, as described above with respect to FIG. 1A. Alternatively, the user-interface may be part of a specific software application running on one or more of the workstations 129. In yet another embodiment, the application may be running on a facility server 126 or the processing system 140, and transmitted to the workstations 129 via the network 130.

While the preceding paragraphs describe several exemplary embodiments of a patient compliance facilitation system, the various embodiments described are not intended to limit the invention to the individual embodiments. Various aspects of the alternate embodiments may be combined in varying ways to create the system and method that best suits the pharmacy implementing the system and method, the pharmacy's customers, the healthcare professionals, the healthcare facilities, and the regulatory environment in which the pharmacy operates.

What is claimed:

1. A method in a computer system of facilitating patient compliance with instructions for proper use of prescription medication after discharge from a healthcare facility, the method comprising:
receiving a patient's opt-in information;
entering the patient's opt-in information into a computer;
receiving, via a computer, a prescription report for the patient, the prescription report including any open prescriptions associated with the patient;
if the prescription report includes one or more open prescriptions:
(a) compiling a list of active prescriptions associated with the patient;
(b) analyzing the list of active prescriptions associated with the patient for contraindications and interactions;
(c) reporting the list of active prescriptions associated with the patient to a healthcare professional;
(d) receiving, via the computer, a verified list of patient current prescriptions, wherein the verified list of patient current prescriptions includes a listing of all medications currently used by the patient; and
(e) closing, via the computer, any open prescriptions associated with the patient if one or more open prescriptions are not listed on the list of patient discharge prescriptions or the verified list of patient current prescriptions;
if the prescription report does not include one or more open prescriptions:
reporting to the healthcare professional that the patient has no open prescriptions;
receiving, via the computer, a list of patient discharge prescriptions, wherein the list of patient discharge prescriptions includes at least a listing of all newly-prescribed medications to be taken by the patient upon discharge from the healthcare facility;
filling the patient discharge prescriptions such that the filled patient discharge prescriptions will supply the patient with enough medication to last for a pre-determined amount of time;
if the verified list of patient current prescriptions includes one or more open prescriptions:
supplementing medications on the verified list of patient current prescriptions such that the supplemented patient current prescriptions will supply the patient with enough medication to last for the pre-determined amount of time;
generating, via the computer, instructions detailing proper use of the patient current prescriptions;
delivering the patient discharge prescriptions, the patient current prescriptions, and the instructions to the patient;
generating, via the computer, a prompt to contact the patient at a first date after the patient has been discharged from the healthcare facility, the first date occurring within the pre-determined amount of time after the patient has been discharged from the healthcare facility; and
generating, via the computer, a prompt to contact the patient at second date after the patient has been discharged from the healthcare facility, the second date occurring within the pre-determined amount of time after the patient has been discharged from the healthcare facility.

2. The method of claim 1 further comprising receiving at least a portion of the prescription report via the Internet.

3. The method of claim 1 further comprising receiving at least a portion of the prescription report from a central pharmacy claims and transactions database.

4. The method of claim 1 further comprising storing at least a portion of the prescription report locally on the computer.

5. The method of claim 1 further comprising including in the prescription report one or more of:
(a) a date when one or more of the open prescriptions were last filled; and
(b) a prescribed dosage for one or more of the open prescriptions.

6. The method of claim 5 wherein compiling a list of active prescriptions includes determining whether any of the one or more open prescriptions should be excluded from the list of active prescriptions.

7. The method of claim 6 wherein determining whether any of the one or more open prescriptions should be excluded from the list of active prescriptions includes analyzing the date when the open prescription was last filled.

8. The method of claim 6 wherein determining whether any of the one or more open prescriptions should be excluded from the list of active prescriptions further comprises analyzing the prescribed dosage for the open prescription.

9. The method of claim 6 further comprising including every one of the one or more open prescriptions associated with the patient in the list of active prescriptions.

10. The method of claim 1 wherein the verified list of patient current prescriptions is the same as the list of active medications.

11. The method of claim 1 further comprising delivering the patient discharge instructions electronically.

12. The method of claim 1 further comprising:
generating, via the computer, one or more questions to ask the patient on the first date after the patient has been discharged from the healthcare facility;
recording one or more responses to the one or more questions to ask the patient on the first date after the patient has been discharged from the healthcare facility;
generating, via the computer, a first report, the first report including information about the responses to the one or more questions to ask the patient on the first date after the patient has been discharged from the healthcare facility;
generating, via the computer, one or more questions to ask the patient on the second date after the patient has been discharged from the healthcare facility;
recording one or more responses to the one or more questions to ask the patient on the second date after the patient has been discharged from the healthcare facility; and
generating, via the computer, a second report, the second report including information about the responses to the one or more questions to ask the patient on the second date after the patient has been discharged from the healthcare facility.

13. The method of claim 12 wherein the one or more questions to ask the patient on the first date after the patient has been discharged from the healthcare facility are designed to solicit information about one or more of:
a) any medication related questions;
b) any side effect issues;
c) any questions for the healthcare professional;
d) any clinical questions;
e) satisfaction with the healthcare professional; or
f) satisfaction with the healthcare services.

14. A system for facilitating patient compliance with instructions for proper use of prescription medication after discharge from a healthcare facility, the system comprising:
one or more computing devices;
storage means, associated with at least one of the one or more computing devices, for maintaining a plurality of customer records, the plurality of customer records each comprising at least a customer identification indicative of a customer, and one or more prescriptions;
means for receiving a prescription report for the patient, the prescription report comprising one or more open prescriptions associated with the patient;
means for analyzing the one or more open prescriptions associated with the patient for contraindications and interactions;
means for reporting the one or more open prescriptions associated with the patient to a healthcare professional;
means for receiving a verified list of patient current prescriptions, wherein the verified list of patient current prescriptions includes at least a listing of all medications currently used by the patient;
means for receiving a list of patient discharge prescriptions, wherein the list of patient discharge prescriptions includes at least a listing of all medications to be taken by the patient upon discharge from the healthcare facility;
means for filling the patient discharge prescriptions such that the filled patient discharge prescriptions will supply the patient with enough medication to last for a pre-determined amount of time;
means for supplementing medications on the verified list of patient current prescriptions such that the filled patient current prescriptions will supply the patient with enough medication to last for the pre-determined amount of time;
means for closing any open prescriptions associated with the patient if one or more open prescriptions are not listed on the list of patient discharge prescriptions or the verified list of patient current prescriptions;
means for composing instructions detailing proper use of the patient current prescriptions;
means for delivering the patient discharge prescriptions, the patient current prescriptions, and the instructions to the patient;
means for contacting the patient at a first date after the patient has been discharged from the healthcare facility, the first date occurring within the pre-determined amount of time after the patient has been discharged from the healthcare facility; and
means for contacting the patient at a second date after the patient has been discharged from the healthcare facility, the second date occurring within the pre-determined amount of time after the patient has been discharged from the healthcare facility.

15. The system of claim 14 further comprising means for determining whether any of the one or more open prescriptions associated with the patient should be excluded from the list of active prescriptions.

16. The system of claim 14 further comprising:
means for generating one or more questions to ask the patient on the first date after the patient has been discharged from the healthcare facility;
means for recording one or more responses to the one or more questions to ask the patient on the first date after the patient has been discharged from the healthcare facility;
means for generating a first report based on the responses to the one or more questions to ask the patient on the first date after the patient has been discharged from the healthcare facility;
means for generating one or more questions to ask the patient on the second date after the patient has been discharged from the healthcare facility;
means for recording one or more responses to the one or more questions to ask the patient on the second date after the patient has been discharged from the healthcare facility; and
means for generating a second report based on the responses to the one or more questions to ask the patient on the second date after the patient has been discharged from the healthcare facility.

17. A user-interface employed in a system for facilitating patient compliance with instructions for proper use of prescription medication after discharge from a healthcare facility, the user-interface comprising:
one or more user-interface screens;
an indication of a prescription report for a patient, the prescription report comprising one or more open prescriptions associated with the patient;
an indication of which, if any, of the one or more open prescriptions associated with the patient may include contraindications and interactions;
an indication of a verified list of patient current prescriptions, wherein the verified list of patient current prescriptions includes at least a listing of all medications currently used by the patient;
an indication of a list of patient discharge prescriptions;
an indication of additional medications on the verified list of patient current prescriptions;
an indication of any open prescriptions associated with the patient that are not listed on the list of patient discharge prescriptions or the verified list of patient current prescriptions;
an indication of directions detailing proper use of the patient current prescriptions;
an indication of a first date on which a patient should be contacted;
an indication of a second date on which a patient should be contacted;
wherein the prescription report may be edited;
wherein the instructions detailing proper use of the patient current prescriptions may be edited;
wherein the first date on which the patient should be contacted may be edited; and
wherein the second date on which the patient should be contacted may be edited.

18. A non-transitory, tangible storage medium configured to store machine-executable instructions operable, when executed by a processor, to cause the processor to execute a method of facilitating patient compliance with instructions for proper use of prescription medication after discharge from a healthcare facility, the instructions operable to cause the processor to:
receive a patient's opt-in information;
receive, via a network, a prescription report for the patient, the prescription report comprising one or more open prescriptions associated with the patient;
determine, for the one or more open prescriptions associated with the patient, whether there exist any contraindications and interactions;
generate a report of the one or more open prescriptions associated with the patient, the report including any contraindications or interactions associated with the one or more open prescriptions;
receive a verified list of patient current prescriptions, wherein the verified list of patient current prescriptions includes a listing of all medications currently used by the patient;
receive a list of patient discharge prescriptions, wherein the list of patient discharge prescriptions includes at least a listing of all medications to be taken by the patient upon discharge from the healthcare facility;
fill the patient discharge prescriptions such that the filled patient discharge prescriptions will supply the patient with enough medication to last for a pre-determined amount of time;
supplement medications on the verified list of patient current prescriptions such that the filled patient current prescriptions will supply the patient with enough medication to last for the pre-determined amount of time;
close any open prescriptions associated with the patient if one or more open prescriptions are not listed on the list of patient discharge prescriptions or the verified list of patient current prescriptions;
generate instructions detailing proper use of the patient current prescriptions and
determine a first date after the patient has been discharged from the healthcare facility on which a pharmacist should contact the patient, the first date occurring within the pre-determined amount of time after the patient has been discharged from the healthcare facility; and
determine a second date after the patient has been discharged from the healthcare facility on which the pharmacist should contact the patient, the second date occurring within the pre-determined amount of time after the patient has been discharged from the healthcare facility.

19. The non-transitory, tangible storage medium storing machine-executable instructions of claim 18, the instructions further operable to cause the processor to analyze a date on which any one of the one or more open prescriptions was last filled.

20. The non-transitory, tangible storage medium storing machine-executable instructions of claim 18, the instructions further operable to cause the processor to:
generate one or more questions to ask the patient on the first date after the patient has been discharged from the healthcare facility;
record one or more responses to the one or more questions to ask the patient on the first date after the patient has been discharged from the healthcare facility;
generate a first report based on the responses to the one or more questions to ask the patient on the first date after the patient has been discharged from the healthcare facility;
generate one or more questions to ask the patient on the second date after the patient has been discharged from the healthcare facility;
record one or more responses to the one or more questions to ask the patient on the second date after the patient has been discharged from the healthcare facility; and
generate a second report based on the responses to the one or more questions to ask the patient on the second date after the patient has been discharged from the healthcare facility.
